(19) United States
(12) Patent Application Publication
(10) Pub. No.: US 2026/0280948 A1
(43) Pub. Date: Sep. 17, 2026

(54) LINEAR MODULATOR FOR SIGNALING AT THZ FREQUENCIES

(71) Applicant: Attotude Inc., Menlo Park, CA (US)

(72) Inventors: Joseph Leslie Middleton, Ottawa (CA); Kuang-Tsan Wu, Ottawa (CA); Rene Schmogrow, Menlo Park, CA (US); David F. Welch, Atherton, CA (US); Joy Laskar, Mountain View, CA (US); Sudipto Chakraborty, Plano, TX (US)

(21) Appl. No.: 19/566,194

(22) Filed: Mar. 13, 2026

Related U.S. Application Data
(60) Provisional application No. 63/771,261, filed on Mar. 13, 2025.

(51) Int. Cl. H04L 27/04; H04L 25/03; H04L 25/49; H04L 27/20; H04L 27/36

(52) U.S. Cl. CPC H04L 27/04; H04L 25/03853; H04L 25/4917; H04L 27/2035; H04L 27/362

(57) ABSTRACT

Systems and methods include a network element, comprising a client-side input, an oscillator, a plurality of modulators, a plurality of frequency-multipliers, a combiner, and an antenna. The client-side input receives a pair of complementary baseband signal components. The oscillator generates a pair of complementary LO signal components. The plurality of modulators modulate the pair of complementary baseband signal components onto the pair of complementary LO signal components to generate a plurality of modulated signals. The plurality of frequency-multipliers multiply a frequency of the plurality of modulated signals to generate a plurality of frequency-multiplied signals. The combiner combines the plurality of frequency-multiplied signals to generate a combined signal. The combined signal has a carrier frequency in a range from 200 Gigahertz (GHz) to 10 Terahertz (THz). The antenna generates a transmission signal as a radiated electromagnetic wave based on the combined signal and couples the transmission signal into a THz waveguide.

### CROSS-REFERENCE TO RELATED APPLICATION

This application claims priority to the provisional patent application identified by U.S. Ser. No. 63/771,261, filed Mar. 13, 2025, the entire content of which is hereby expressly incorporated herein by reference.

### BACKGROUND OF THE INVENTION

Generation of linearly modulated signals at Terahertz (THz) frequencies presents significant technical challenges in contemporary semiconductor technologies. These challenges are particularly pronounced in Silicon-based technologies due to their inherent frequency limitations, including their maximum operating frequency (Fₘₐₓ). This fundamental limitation has necessitated the exploration of alternative approaches, including the integration of different semiconductor technologies through chiplet-based solutions. One proposed solution involves the integration of Silicon and Group III-V semiconductor technologies within a single package. While this approach theoretically combines the advantages of both technology families, it introduces its own set of challenges. The primary difficulties arise from manufacturing yield concerns and the complexity of creating reliable interfaces between different semiconductor technologies.

Furthermore, the implementation of linear modulation at THz frequencies faces additional challenges related to power efficiency and local oscillator (LO) signal generation. The generation of suitably large-amplitude LO signals, which are essential for implementing effective modulators, becomes increasingly difficult at these frequencies. This challenge is compounded by the inherent characteristics of high-frequency THz mixers, which produce output signals where only half of the power appears at the desired frequency of interest.

This phenomenon can be mathematically expressed for double-sideband (DSB) modulation as Y=A cos(ω_{BB}t) cos(ω_{LO}t)=0.5A[cos(ω_{LO}−ω_{BB})t+cos(ω_{LO}+ω_{BB})t], where A represents the amplitude, ω_{BB} is the baseband frequency, and ω_{LO} is the local oscillator frequency. For single-sideband (SSB) modulation, the relationship is expressed as Y=A cos(ω_{BB}T) cos(ω_{LO}t)+A sin(ω_{BB}T) sin(ω_{LO}t)=A[cos(ω_{LO}−ω_{BB})t].

These mathematical relationships highlight the fundamental efficiency limitations in traditional modulation approaches at THz frequencies. The DSB output contains two sidebands, effectively splitting the signal power between desired and undesired frequency components, while the SSB implementation requires more complex circuitry to generate the quadrature signals necessary for single-sideband operation.

These challenges collectively represent significant obstacles in the development of efficient and practical THz communication systems, particularly for applications requiring high-speed data transmission or precise frequency control. The limitations of current approaches necessitate the development of novel solutions that can address these fundamental technical constraints while maintaining manufacturability and reliability.

### SUMMARY OF THE INVENTION

A method and system are disclosed. The problem of generating linearly modulated signals at Terahertz (THz) frequencies is addressed through the inventive concepts disclosed herein.

In a first aspect, the present disclosure includes a network element, comprising: a client-side input operable to receive a differential baseband signal comprising a pair of complementary baseband signal components; an oscillation circuit operable to generate a differential local oscillator (LO) signal having an LO frequency in a range from 100 Gigahertz (GHz) to 500 GHz and comprising a pair of complementary LO signal components; a plurality of modulation circuits operable to generate a plurality of modulated signals, each of the plurality of modulation circuits being operable to receive a particular complementary baseband signal component of the pair of complementary baseband signal components and a particular complementary LO signal component of the pair of complementary LO signal components and modulate the particular complementary baseband signal component onto the particular complementary LO signal component to generate a particular one of the plurality of modulated signals; a plurality of frequency multiplication circuits operable to generate a plurality of frequency-multiplied signals, each of the plurality of frequency multiplication circuits being operable to receive a particular one of the plurality of modulated signals and multiply a frequency of the particular one of the plurality of modulated signals to generate a particular one of the plurality of frequency-multiplied signals; a combination circuit operable to receive the plurality of frequency-multiplied signals and combine each of the plurality of frequency-multiplied signals to generate a combined signal having a carrier frequency in a range from 200 GHz to 10 Terahertz (THz); and an antenna operable to receive the combined signal, generate a transmission signal as a radiated electromagnetic wave based on the combined signal, and couple the transmission signal into a THz waveguide.

In a second aspect, the present disclosure includes a network element, comprising: a client-side input operable to receive a differential baseband signal comprising a pair of complementary baseband signal components including a first complementary baseband signal component and a second complementary baseband signal component, the first complementary baseband signal component including a first in-phase (I) baseband signal component and a first quadrature (Q) baseband signal component, the second complementary baseband signal component including a second I baseband signal component and a second Q baseband signal component; an oscillation circuit operable to generate a differential local oscillator (LO) signal having an LO frequency in a range from 100 Gigahertz (GHz) to 500 GHz and comprising a pair of complementary LO signal components including a first complementary LO signal component and a second complementary LO signal component, the first complementary LO signal component including a first I LO signal component and a first Q LO signal component, the second complementary LO signal component including a second I LO signal component and a second Q LO signal component; a first frequency multiplication circuit operable to receive the first I baseband signal component, the second I baseband signal component, the first I LO signal component, and the second I LO signal component and generate a first frequency-multiplied signal based on the first I baseband signal component, the second I baseband signal component, the first I LO signal component, and the second I LO signal component, the first frequency-multiplied signal having a first intermediate frequency greater than the LO frequency; a second frequency multiplication circuit operable to receive the first Q baseband signal component, the second Q baseband signal component, the first Q LO signal component, and the second Q LO signal component and generate a second frequency-multiplied signal based on the first Q baseband signal component, the second Q baseband signal component, the first Q LO signal component, and the second Q LO signal component, the second frequency-multiplied signal having a second intermediate frequency greater than the LO frequency; a combination circuit operable to receive the first frequency-multiplied signal and the second frequency-multiplied signal and combine the first frequency-multiplied signal and the second frequency-multiplied signal to generate a combined signal having a carrier frequency in a range from 200 GHz to 10 THz; and an antenna operable to receive the combined signal, generate a transmission signal as a radiated electromagnetic wave based on the combined signal, and couple the transmission signal into a THz waveguide.

The foregoing summary provides an overview of certain selected implementations or embodiments disclosed herein, and is not intended to describe every aspect, embodiment, implementation, feature, or advantage of the disclosure exhaustively or comprehensively. Therefore, this summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a frequency-wavelength diagram of the electromagnetic (EM) spectrum;

FIG. 2 is a block diagram of an exemplary embodiment of a transport network constructed in accordance with the present disclosure;

FIG. 3 is a block diagram of an exemplary embodiment of a user device of the transport network shown in FIG. 2;

FIG. 4 is a block diagram of an exemplary embodiment of a network administrator device of the transport network shown in FIG. 2;

FIG. 5 is a block diagram of an exemplary embodiment of a first network element of the transport network shown in FIG. 2;

FIG. 6 is a block diagram of an exemplary embodiment of transmitter circuitry shown in FIG. 5;

FIG. 7 is a block diagram of another exemplary embodiment of the transmitter circuitry shown in FIG. 5;

FIG. 8A is a circuit diagram of an exemplary embodiment of a modulation circuit shown in FIGS. 6 and 7;

FIG. 8B is a circuit diagram of another exemplary embodiment of the modulation circuit shown in FIGS. 6 and 7;

FIG. 9A is a circuit diagram of an exemplary embodiment of a frequency multiplication circuit shown in FIGS. 6 and 7;

FIG. 9B is a circuit diagram of another exemplary embodiment of the frequency multiplication circuit shown in FIGS. 6 and 7;

FIG. 9C is a circuit diagram of another exemplary embodiment of the frequency multiplication circuit shown in FIGS. 6 and 7;

FIG. 9D is a circuit diagram of another exemplary embodiment of the frequency multiplication circuit shown in FIGS. 6 and 7;

FIG. 10A is a circuit diagram of an exemplary embodiment of a combination circuit shown in FIGS. 6 and 7;

FIG. 10B is a circuit diagram of another exemplary embodiment of the combination circuit shown in FIGS. 6 and 7;

FIG. 11 is a spectral graph of an exemplary embodiment of a combined signal generated by the transmitter circuitry shown in FIGS. 6 and 7; and

FIG. 12 is a complex eye diagram of another exemplary embodiment of the combined signal generated by the transmitter circuitry shown in FIGS. 6 and 7, showing a real amplitude and an imaginary amplitude of the combined signal.

### DETAILED DESCRIPTION OF THE INVENTION

The following detailed description refers to the accompanying drawings. The same reference numbers in different drawings may identify the same or similar elements.

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise. That is, the use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

As used herein, “circuitry” may be analog and/or digital components, or one or more suitably programmed processors (e.g., microprocessors) and associated hardware and software, or hardwired logic. Also, “components” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

As used herein, “software” may include one or more computer readable instruction that when executed by one or more processing components (e.g., a processor) causes the processing component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, a phase change memory, combinations thereof, and/or the like. Such non-transitory computer-readable media may be electrically based, optically based, magnetically based, material-phase based, resistive based, and/or the like. Further, the messages described herein may be generated by the processing component and result in various physical transformations.

As used herein, “hollow waveguide” refers to a structure that guides waves by restricting transmission of energy in a particular direction. In the context of the present disclosure, “hollow waveguide” may refer to an optical fiber having a waveguide core operable to propagate RF signals in the THz frequency band or a routed waveguide operable to propagate RF signals in the THz frequency band.

As used herein, “THz waveguide” refers to a structure that guides waves in the THz band by propagating the waves in a particular direction and restricting transmission of energy in another direction. An example of the THz waveguide described herein is a hollow waveguide.

As used herein, a “mode” refers to a unique distribution of electric and magnetic fields which repeat along the length of a THz waveguide by which electromagnetic energy may be transported through the THz waveguide. “Single-mode” refers to a THz waveguide designed to carry only one mode of electromagnetic wave. This is achieved by having a narrow core diameter, which allows only one mode of light to propagate at a time. On the other hand, “multi-mode” refers to a THz waveguide designed to carry multiple modes of electromagnetic waves simultaneously. This is possibly due to its larger core diameter, which enables multiple modes to be propagated.

As used herein, “diameter” refers to a straight line passing from side to side through the center of a body or figure. In some embodiments, the body or figure has a circular shape having a single diameter or an elliptical shape having multiple different diameters.

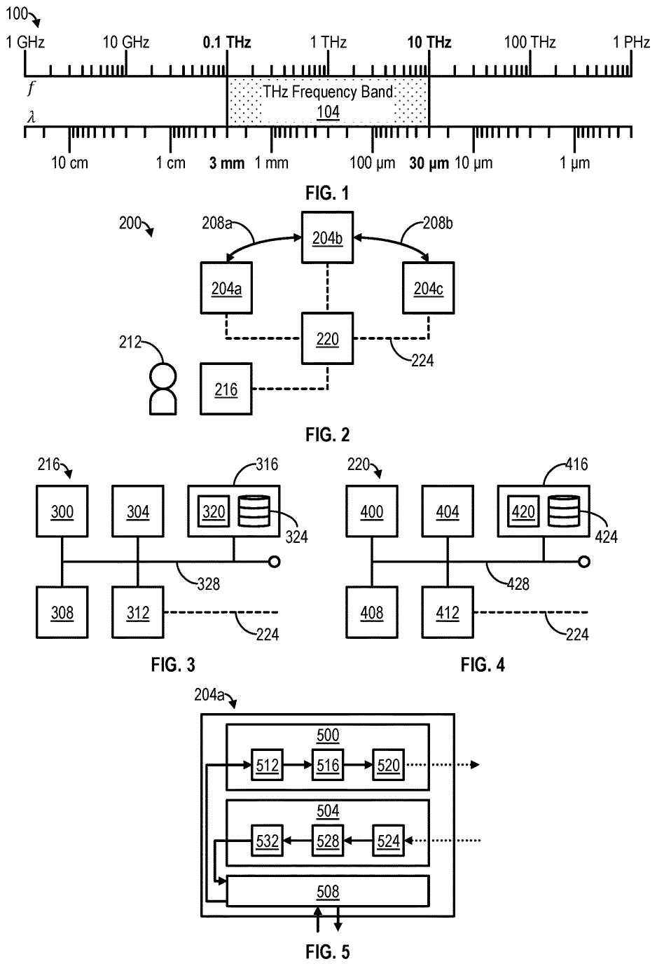

Referring now to the drawings, and in particular to FIG. 1, shown therein is a frequency-wavelength diagram of the electromagnetic (EM) spectrum 100. As shown in FIG. 1, frequency and wavelength have an inverse relationship; that is, as the frequency of a signal increases, the wavelength of the signal decreases, and vice versa. The present disclosure is generally related to transport networks (shown in FIG. 2) and network elements (shown in FIG. 2) that communicate using signals comprising radiated electromagnetic waves coupled into Terahertz (THz) waveguides, such as hollow waveguides, for example. Such signals generally have a frequency in what is referred to as the THz frequency band 104, which corresponds to frequencies in a range between 0.1 THz and 10 THz and wavelengths in a range from 3 millimeters (mm) to 30 micrometers (μm). However, in some embodiments, the signals may have a frequency in a different range, such as from 300 Gigahertz (GHz) to 3 THz, from 300 GHz to 10 THz, from 500 GHz to 3 THz, or from 200 GHz to 10 THz, for example.

Referring now to FIG. 2, shown therein is a block diagram of an exemplary embodiment of a transport network 200 constructed in accordance with the present disclosure. As shown in FIG. 2, the transport network 200 generally comprises a plurality of network elements 204a-n (hereinafter the “network elements 204” or individually each a “network element 204”) (e.g., a first network element 204a, a second network element 204b, and a third network element 204c shown in FIG. 2) which may communicate with each other using one or more THz waveguides shown and described herein by way of example as hollow waveguides 208a-n (hereinafter the “hollow waveguides 208” or individually each a “hollow waveguide 208”) (e.g., a first hollow waveguide 208a and a second hollow waveguide 208b shown in FIG. 2). The THz waveguides may comprise a dielectric material. In some embodiments, the dielectric material of the THz waveguides may be selected from a group consisting of: high-resistivity float zone silicon (HRFZ-Si), germanium (Ge), and diamond-like carbon (DLC). In some embodiments, the THz waveguides are constructed of a non-polymer material. The non-polymer material may be a material that performs as a semiconductor material at a frequency less than the THz frequency band 104, and as a dielectric material at a frequency within the THz frequency band 104. High-resistivity float zone silicon (HRFZ-Si), germanium (Ge), and diamond-like carbon (DLC) are examples of non-polymer materials that perform as a semiconductor material at a frequency less than the THz frequency band 104, and as a dielectric material at a frequency within the THz frequency band 104.

While three of the network elements 204 are shown in FIG. 2, it should be understood that the transport network 200 may comprise a number of the network elements 204 that is greater or less than three. Further, while two of the hollow waveguides 208 are shown in FIG. 2, it should be understood that the transport network 200 may comprise a number of the hollow waveguides 208 that is greater or less than two.

In some embodiments of the transport network 200, a user 212 may interact with the transport network 200 using a user device 216 that may be used to request, such as from a network administrator device 220, a user interface application (shown in FIG. 3) which may be operable to accept input from the user 212 which may be transmitted to at least one of the network elements 204. In some such embodiments, the network administrator device 220 may be connected to the transport network 200 and the user device 216 via a communication network 224.

The communication network 224 may interface by optical and/or electronic interfaces and/or use a variety of network topographies and/or protocols to permit bidirectional interface and/or communication of signals and/or data between the network elements 204, the user device 216, and the network administrator device 220. The communication network 224 may interface with the network elements 204, the user device 216, and the network administrator device 220 in a variety of ways. For example, in some embodiments, the communication network 224 may be the World Wide Web (i.e., the Internet). In some such embodiments, a user interface of the transport network 200 may be delivered through a series of web pages or private internal web pages of a company or corporation, which may be written in Hypertext Markup Language (HTML), Hypertext Preprocessor (PHP), or JavaScript, for example, and may be accessible by the user device 216. It should be noted that the user interface of the transport network 200 may be another type of interface including, but not limited to, a desktop application such as a Windows-based application, a Linux-based application, or a macOS-based application, for example; a web browser interface; a command-line interface; a graphical user interface (GUI); a cloud-based interface; an API interface; a server-based application; a tablet-based application; a mobile web interface; an application running on a mobile device; a virtual-reality interface; an augmented-reality interface; a touch screen interface; a voice-or gesture-controlled interface; a wearable device interface; and/or the like.

While the communication network 224 is described above as being the World Wide Web (i.e., the Internet), it should be noted that the communication network 224 may be almost any type of network and may be implemented as a Local Area Network (LAN), a Wide-Area Network (WAN), a Low-Power Wide-Area Network (LPWAN), a Long Range (LoRa) network, a metropolitan network, a wireless network, a Wi-Fi network, a cellular network, a Bluetooth network, a Global System for Mobile Communications (GSM) network, a Code Division Multiple Access (CDMA) network, a Third Generation (3G) network, a Fourth Generation (4G) network, a Long Term Evolution (LTE) network, a Fifth Generation (5G) network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

In some embodiments, the transport network 200 may be deployed in environments where local power supplies are unavailable, such as within submarine or underwater cables, for example.

The number of devices and/or networks illustrated in FIG. 2 is provided for explanatory purposes. In practice, there may be additional devices and/or networks, fewer devices and/or networks, different devices and/or networks, or differently arranged devices and/or networks than are shown in FIG. 2. Furthermore, two or more of the devices illustrated in FIG. 2 may be implemented within a single device, or a single device illustrated in FIG. 2 may be implemented as multiple, distributed devices. Additionally, or alternatively, one or more of the devices of the transport network 200 may perform one or more functions described as being performed by another one or more of the devices of the transport network 200. Devices of the transport network 200 may interconnect via wired connections, wireless connections, or a combination thereof.

Referring now to FIG. 3, shown therein is a block diagram of an exemplary embodiment of the user device 216 of the transport network 200 constructed in accordance with the present disclosure. In some embodiments, the user device 216 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a virtual reality (VR)/augmented reality (AR) device, and/or the like.

As shown in FIG. 3, the user device 216 generally includes one or more user input devices 300a-n (hereinafter the “user input device 300”), one or more user output devices 304a-n (hereinafter the “user output device 304”), one or more user processors 308a-n (hereinafter the “user processor 308”), one or more user communication devices 312a-n (hereinafter the “user communication device 312”), and one or more user memories 316a-n (hereinafter the “user memory 316”) storing one or more user software applications 320a-n (hereinafter the “user software application 320”) comprising processor-executable instructions and/or one or more user databases 324a-n (hereinafter the “user database 324”). The user input device 300, the user output device 304, the user processor 308, the user communication device 312, and the user memory 316 may be connected via a user path 328 such as a data bus that permits communication among the components of the user device 216.

The user input device 300 may be capable of receiving information input from the user processor 308 and/or the user 212, and transmitting such information to other components of the user device 216 and/or the communication network 224. The user input device 300 may include, but is not limited to, implementation as a keyboard, a touchscreen, a mouse, a trackball, a microphone, a camera, a fingerprint reader, an infrared port, an optical port, a cell phone, a smart phone, a Personal Digital Assistant (PDA), a remote control, a fax machine, a wearable communication device, a network interface, combinations thereof, and/or the like, for example.

The user output device 304 may be capable of outputting information in a form perceivable by the user processor 308 and/or the user 212. The user output device 304 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the user input device 300 and the user output device 304 may be implemented as a single device, such as, for example, a touchscreen of a computer, a tablet, or a smartphone. It is to be further understood that as used herein the term “user” (i.e., the user 212) is not limited to a human being, and may comprise a computer, a server, a website, a processor, a network interface, a user terminal, a virtual computer, combinations thereof, and/or the like, for example. The user output device 304 may display the user interface on the user device 216.

The user processor 308 may include, but is not limited to, implementation as a processor, a microprocessor, a mobile processor, a System on a Chip (SoC), a Central Processing Unit (CPU), a Microcontroller (MCU), a Digital Signal Processor (DSP), an Application Specific Integrated Circuit (ASIC), a Field Programmable Gate Array (FPGA), a Tensor Processing Unit (TPU), a Graphics Processing Unit (GPU), a combination of hardware and software, and/or the like. The user processor 308 may be capable of communicating with the user input device 300, the user output device 304, the user communication device 312, and/or the user memory 316 via the user path 328. The user processor 308 may include one or more of the user processor 308 working together or independently and located locally or remotely (e.g., accessible via the communication network 224).

The user communication device 312, in communication with the user processor 308, may interface with the communication network 224. For example, the user processor 308 may be capable of communicating via the communication network 224 by exchanging signals (e.g., analog, digital, optical, and/or the like) via one or more ports (e.g., physical or virtual ports) using a network protocol to communicate signals and/or data with the network administrator device 220 and/or transport network 200.

The user memory 316 may comprise one or more non-transitory processor-readable media. The user memory 316 may store the user software application 320 that, when executed by the user processor 308, causes the user device 216 to perform an action such as communicate with or control one or more component of the user device 216 and/or, via the communication network 224, the transport network 200. The user memory 316 may include one or more of the user memory 316 working together or independently to store processor-executable code and may be located locally or remotely (e.g., accessible via the communication network 224). The user software application 320 may include, for example, a web browser capable of accessing a website and/or communicating signals and/or data over a wireless or wired network (e.g., the communication network 224) and/or the like.

The user database 324 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The user database 324 may be centralized or distributed across multiple systems.

The number of devices and/or networks illustrated in FIG. 3 is provided for explanatory purposes. In practice, there may be additional devices and/or networks, fewer devices and/or networks, different devices and/or networks, or differently arranged devices and/or networks than are shown in FIG. 3. Furthermore, two or more of the components or devices illustrated in FIG. 3 may be implemented within a single component or device, or a single component or device illustrated in FIG. 3 may be implemented as multiple, distributed components or devices. Additionally, or alternatively, one or more of the components or devices of the user device 216 may perform one or more functions described as being performed by another one or more of the components or devices of the user device 216. Components or devices of the user device 216 may interconnect via wired connections, wireless connections, or a combination thereof. For example, in one embodiment, the user device 216 and the network administrator device 220 may be integrated into the same device; that is, the user device 216 may perform functions and/or processes described as being performed by the network administrator device 220, described in more detail below.

Referring now to FIG. 4, shown therein is a block diagram of an exemplary embodiment of the network administrator device 220 of the transport network 200 constructed in accordance with the present disclosure. In some embodiments, the network administrator device 220 may include, but is not limited to, implementation as a personal computer, a cellular telephone, a smart phone, a network-capable television set, a tablet, a laptop computer, a desktop computer, a network-capable handheld device, a server, a digital video recorder, a wearable network-capable device, a VR/AR device, and/or the like.

As shown in FIG. 4, the network administrator device 220 generally includes one or more administrator input devices 400a-n (hereinafter the “administrator input device 400”), one or more administrator output devices 404a-n (hereinafter the “administrator output device 404”), one or more administrator processors 408a-n (hereinafter the “administrator processor 408”), one or more administrator communication devices 412a-n (hereinafter the “administrator communication device 412”), and one or more administrator memories 416a-n (hereinafter the “administrator memory 416”) storing one or more administrator software applications 420a-n (hereinafter the “administrator software application 420”) comprising processor-executable instructions and/or one or more administrator databases 424a-n (hereinafter the “administrator database 424”). The administrator input device 400, the administrator output device 404, the administrator processor 408, the administrator communication device 412, and the administrator memory 416 may be connected via an administrator path 428 such as a data bus that permits communication among the components of the network administrator device 220.

The administrator input device 400 may be capable of receiving information input from the administrator processor 408 and/or the user 212, and transmitting such information to other components of the network administrator device 220 and/or the communication network 224. The administrator input device 400 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example.

The administrator output device 404 may be capable of outputting information in a form perceivable by the administrator processor 408 and/or the user 212. The administrator output device 404 may include, but is not limited to, implementation as a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and/or the like, for example. It is to be understood that in some exemplary embodiments, the administrator input device 400 and the administrator output device 404 may be implemented as a single device, such as, for example, a touchscreen of a computer, a tablet, or a smartphone. The administrator output device 404 may display the user interface on the network administrator device 220.

The administrator processor 408 may include, but is not limited to, implementation as a processor, a microprocessor, a mobile processor, an SoC, a CPU, an MCU, a DSP, an ASIC, an FPGA, a TPU, a GPU, a combination of hardware and software, and/or the like. The administrator processor 408 may be capable of communicating with the administrator input device 400, the administrator output device 404, the administrator communication device 412, and/or the administrator memory 416 via the administrator path 428. The administrator processor 408 may include one or more of the administrator processor 408 working together or independently and located locally or remotely (e.g., accessible via the communication network 224).

The administrator communication device 412, in communication with the administrator processor 408, may interface with the communication network 224. For example, the administrator processor 408 may be capable of communicating via the communication network 224 by exchanging signals (e.g., analog, digital, optical, and/or the like) via one or more ports (e.g., physical or virtual ports) using a network protocol to communicate signals and/or data with the user device 216 and/or the transport network 200.

The administrator memory 416 may comprise one or more non-transitory processor-readable media. The administrator memory 416 may store the administrator software application 420 that, when executed by the administrator processor 408, causes the network administrator device 220 to perform an action such as communicate with or control one or more component of the network administrator device 220 and/or, via the communication network 224, the transport network 200. The administrator memory 416 may include one or more of the administrator memory 416 working together or independently to store processor-executable code and may be located locally or remotely (e.g., accessible via the communication network 224). The administrator software application 420 may include, for example, a web browser capable of accessing a website and/or communicating signals and/or data over a wireless or wired network (e.g., the communication network 224) and/or the like.

The number of devices and/or networks illustrated in FIG. 4 is provided for explanatory purposes. In practice, there may be additional devices and/or networks, fewer devices and/or networks, different devices and/or networks, or differently arranged devices and/or networks than are shown in FIG. 4. Furthermore, two or more of the components or devices illustrated in FIG. 4 may be implemented within a single component or device, or a single component or device illustrated in FIG. 4 may be implemented as multiple, distributed components or devices. Additionally, or alternatively, one or more of the components or devices of the network administrator device 220 may perform one or more functions described as being performed by another one or more of the components or devices of the network administrator device 220. Components or devices of the network administrator device 220 may interconnect via wired connections, wireless connections, or a combination thereof. For example, in one embodiment, the user device 216 and the network administrator device 220 may be integrated into the same device; that is, the network administrator device 220 may perform functions and/or processes described as being performed by the user device 216 described above, or vice versa.

The administrator database 424 may be a relational database, a time-series database, a vector database, a non-relational database, or the like. Examples of such databases comprise DB2®, Microsoft® Access, Microsoft® SQL Server, Oracle®, MySQL, PostgreSQL, MongoDB, Apache Cassandra, Weaviate, and the like. It should be understood that these examples have been provided for the purposes of illustration only and should not be construed as limiting the presently disclosed inventive concepts. The administrator database 424 may be centralized or distributed across multiple systems.

Referring now to FIG. 5, shown therein is a block diagram of an exemplary embodiment of the first network element 204a shown in FIG. 2. However, it should be understood that the description below may be applicable to any of the network elements 204 described herein. As shown in FIG. 5, the first network element 204a—and, therefore, any of the network elements 204 described herein—may comprise one or more of a transmitter 500 and a receiver 504 in addition to a controller 508.

The transmitter 500 is generally operable to receive outbound baseband signals (i.e., conducted electrical signals) having outbound data encoded therein from a source external to the transmitter 500 (e.g., the controller 508), generate outbound radiated signals (i.e., signals comprising radiated electromagnetic waves) based on the outbound baseband signals, and transmit and/or couple the outbound radiated signals into one of the hollow waveguides 208 (e.g., the first hollow waveguide 208a).

As shown in FIG. 5, the transmitter 500 may comprise a client-side input 512 operable to receive the outbound baseband signals, transmitter circuitry 516 operable to receive the outbound baseband signals from the client-side input 512 and generate antenna feed signals based on the outbound baseband signals, and a transmitter antenna array 520 comprising one or more transmitter antennas and operable to receive the antenna feed signals from the transmitter circuitry 516, generate the outbound radiated signals based on the antenna feed signals, and transmit and/or couple the outbound radiated signals into one of the hollow waveguides 208 (e.g., the first hollow waveguide 208a).

In some embodiments, as described in more detail below, the client-side input 512 may receive the outbound baseband signals as outbound differential baseband signals, each of the outbound differential baseband signals having a pair of complementary baseband signal components (hereinafter the “baseband signal components” or individually each a “baseband signal component”) including a positive baseband signal component and a negative baseband signal component.

The receiver 504 is generally operable to receive, detect, and/or decode inbound radiated signals from one of the hollow waveguides 208 (e.g., the first hollow waveguide 208a), generate inbound baseband signals based on the inbound radiated signals, and transmit the inbound baseband signals having inbound data encoded therein to a destination external to the receiver 504 (e.g., the controller 508). As shown in FIG. 5, the receiver 504 may comprise a receiver antenna array 524 comprising one or more receiver antennas and operable to receive, detect, and/or decode the inbound radiated signals from one of the hollow waveguides 208 (e.g., the first hollow waveguide 208a) and generate antenna output signals based on the inbound radiated signals, receiver circuitry 528 operable to receive the antenna output signals from the receiver antenna array 524 and generate inbound baseband signals based on the antenna output signals, and a client-side output 532 operable to receive the inbound baseband signals from the receiver circuitry 528 and send the inbound baseband signals to a destination external to the receiver 504 (e.g., the controller 508).

The outbound data and the inbound data may be encoded in the outbound baseband signals and the inbound baseband signals, respectively, using a modulation format such as a pulse amplitude modulation-n (PAM-n) format (n being an integer), an m-quadrature amplitude modulation (m-QAM) format (m being an integer), and a quadrature phase-shift keying (QPSK) modulation format, for example.

The controller 508 is generally operable to regulate one or more operating parameters of the transmitter 500, the receiver 504, and/or the first network element 204a and/or send and/or receive signals and/or data to and/or from the transmitter 500 and/or the receiver 504.

Nonexclusive examples of how to make and use the transmitter 500 (including but not limited to the client-side input 512, the transmitter circuitry 516, and the transmitter antenna array 520), the receiver 504 (including but not limited to the receiver antenna array 524, the receiver circuitry 528, and the client-side output 532), and the hollow waveguide 208 are further described in U.S. patent application Ser. No. 18/927,535, titled “Fiber-Coupled Terahertz RF Transceiver System”, filed on Oct. 25, 2024, the entire contents of which are hereby incorporated herein by reference in their entirety.

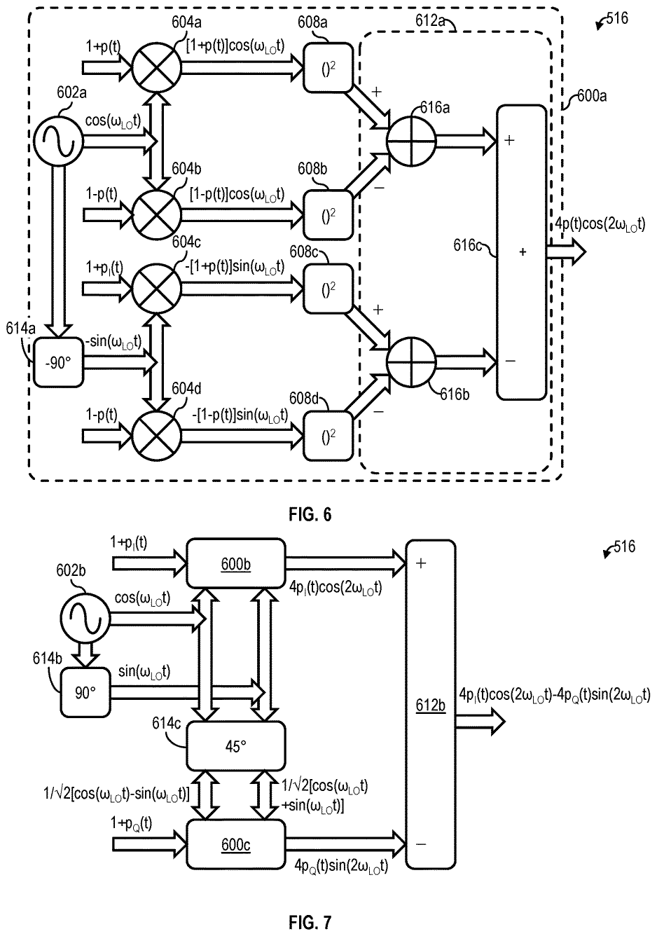

Referring now to FIG. 6, shown therein is an exemplary embodiment of the transmitter circuitry 516 shown in FIG. 5. In the embodiment shown in FIG. 6, the transmitter circuitry 516 may be configured to implement DSB modulation. In accordance with the present disclosure, the transmitter circuitry 516 may comprise one or more frequency multiplication circuit sections 600a-n (hereinafter the “frequency multiplier slices 600” or individually each a “frequency multiplier slice 600”) (e.g., a first frequency multiplier slice 600a shown in FIG. 6).

As discussed above, the transmitter circuitry 516 may be operable to receive an outbound baseband signal (hereinafter the “baseband signal”) (BB) p(t) from the client-side input 512 and generate an antenna feed signal based on the baseband signal. In some embodiments, as discussed above, the baseband signal may be a differential baseband signal comprising the baseband signal components including the positive baseband signal component (BB+) 1+p(t) and the negative baseband signal component (BB−) 1−p(t).

In some embodiments, the transmitter circuitry 516 may further comprise a pulse-shaping circuit operable to receive the baseband signal components and shape a pulse of each of the baseband signal components to apply a predetermined pulse shape to the pulse of each of the baseband signal components. The pulse-shaping circuit may be operable to apply a filter (i.e., a digital filter or an analog filter) and/or pre-emphasis (i.e., selective amplification of particular spectral elements of a signal-in some embodiments, frequencies, or particularly higher frequencies in some such embodiments-to counteract any frequency-dependent attenuation characteristics and/or bandwidth limitations of the client-side input 512) to each of the baseband signal components to reduce a bandwidth of each of the baseband signal components.

As shown in FIG. 6, the first frequency multiplier slice 600a may comprise a first local oscillation (LO) circuit 602a (hereinafter the “first LO 602a”), a plurality of modulation circuits 604a-n (hereinafter the “modulators 604” or individually each a “modulator 604”) (e.g., a first modulator 604a, a second modulator 604b, a third modulator 604c, and a fourth modulator 604d shown in FIG. 6), a plurality of frequency multiplication circuits 608a-n (hereinafter the “frequency multipliers 608” or individually each a “frequency multiplier 608”) (e.g., a first frequency multiplier 608a, a second frequency multiplier 608b, a third frequency multiplier 608c, and a fourth frequency multiplier 608d shown in FIG. 6), and a first multiple combination circuit network 612a (hereinafter the “first multi-combiner network 612a”). In some embodiments, the transmitter circuitry 516 further comprises a first phase shift circuit 614a (hereinafter the “first phase shifter 614a”).

The first LO 602a may be operable to generate an LO signal (LO) cos(ω_{LO}t) having an LO frequency ω_{LO} in a range from 100 GHz to 500 GHz. However, in other embodiments, the LO frequency ω_{LO} may be in a different range, such as from 150 GHz to 400 GHz, from 200 GHz to 300 GHz, or from 100 GHz to 300 GHz, for example.

In some embodiments, the LO signal cos(ω_{LO}t) may be a differential LO signal comprising a pair of complementary LO signal components (hereinafter the “LO signal components” or individually each an “LO signal component”) including a positive LO signal component (LO+) and a negative LO signal component (LO−).

In some embodiments, the first LO 602a and the first phase shifter 614a may be collectively described as an “oscillation circuit”. In such embodiments, the first LO 602a may be operable to generate a single-ended reference LO signal cos(ω_{LO}t), and the first phase shifter 614a may be operable to receive the single-ended reference LO signal cos(ω_{LO}t) and adjust a phase of the single-ended reference LO signal cos(ω_{LO}t) to generate a first phase-shifted reference LO signal−sin(ω_{LO}t). In some such embodiments, as shown in FIG. 6, the first phase shifter 614a may be operable to adjust the phase of the single-ended reference LO signal cos(ω_{LO}t) by −90 degrees to generate the first phase-shifted reference LO signal−sin(ω_{LO}t) (i.e., the negative LO signal component (LO−) of the LO signal cos(ω_{LO}t)). In such embodiments, the positive LO signal component (LO+) of the LO signal cos(ω_{LO}t) may be the single-ended reference LO signal cos(ω_{LO}t).

In some embodiments, the first frequency multiplier slice 600a may further comprise a phase and/or amplitude calibration circuit operable to receive one or more of the LO signal components and modify a phase and/or an amplitude of one or more of the LO signal components such that the LO signal components are orthogonal to each other and/or the amplitudes of the LO signal components are equalized.

The modulators 604 may be operable to generate a plurality of modulated signals (hereinafter the “modulated signals” or individually each a “modulated signal”). That is, each particular modulator 604 may be operable to receive a particular baseband signal component and a particular LO signal component and modulate the particular baseband signal component onto the particular LO signal component to generate a particular modulated signal of the modulated signals.

In certain embodiments, one or more of the modulators 604 may be a real modulation circuit, a complex modulation circuit, a DSB mixing circuit, and an SSB mixing circuit.

The first modulator 604a may be operable to receive the positive baseband signal component 1+p(t) and the LO signal cos(ω_{LO}t) and modulate the positive baseband signal component 1+p(t) onto the LO signal cos(ω_{LO}t) to generate a first modulated signal [1+p(t)] cos(ω_{LO}t) of the modulated signals.

The second modulator 604b may be operable to receive the negative baseband signal component 1−p(t) and the LO signal (or in some embodiments a particular LO signal component) cos(ω_{LO}t) and modulate the negative baseband signal component 1−p(t) onto the LO signal cos(ω_{LO}t) to generate a second modulated signal [1−p(t)] cos(ω_{LO}t) of the modulated signals.

The third modulator 604c may be operable to receive the positive baseband signal component 1+p(t) and the first phase-shifted LO signal−sin(ω_{LO}t) and modulate the positive baseband signal component 1+p(t) onto the first phase-shifted LO signal−sin (ω_{LO}t) to generate a third modulated signal−[1+p(t)] sin(ω_{LO}t) of modulated signals.

The fourth modulator 604d may be operable to receive the negative baseband signal component 1−p(t) and the first phase-shifted LO signal (or in some embodiments a particular LO signal component)−sin(ω_{LO}t) and modulate the negative baseband signal component 1−p(t) onto the first phase-shifted LO signal−sin(ω_{LO}t) to generate a fourth modulated signal−[1−p(t)] sin(ω_{LO}t) of the modulated signals.

The frequency multipliers 608 may be operable to generate a plurality of frequency-multiplied signals (hereinafter the “frequency-multiplied signals” or individually each a “frequency-multiplied signal”). That is, each particular frequency multiplier 608 may be operable to receive a particular modulated signal and multiply a frequency of the particular modulated signal by an integer value (i.e., even or odd) to generate a particular frequency-multiplied signal. In some embodiments, one or more of the frequency multipliers 608 is a frequency-doubling circuit configured to double the frequency of the particular modulated signal to generate the particular frequency-multiplied signal.

The first frequency multiplier 608a may be operable to receive the first modulated signal [1+p(t)] cos(ω_{LO}t) and multiply a frequency of the first modulated signal [1+p(t)] cos(ω_{LO}t) to generate a first frequency-multiplied signal (Y_{1A}) [1+p(t)]² cos²(ω_{LO}t) of the frequency-multiplied signals.

The second frequency multiplier 608b may be operable to receive the second modulated signal [1−p(t)] cos(ω_{LO}t) and multiply a frequency of the second modulated signal [1−p(t)] cos(ω_{LO}t) to generate a second frequency-multiplied signal (Y_{1B}) [1−p(t)]² cos²(ω_{LO}t) of the frequency-multiplied signals.

The third frequency multiplier 608c may be operable to receive the third modulated signal−[1+p(t)] sin(ω_{LO}t) and multiply a frequency of the third modulated signal−[1+p(t)] sin(ω_{LO}t) to generate a third frequency-multiplied signal (Y_{2A}) [1+p(t)]² sin²(ω_{LO}T) of the frequency-multiplied signals.

The fourth frequency multiplier 608d may be operable to receive the fourth modulated signal−[1−p(t)] sin(ω_{LO}t) and multiply a frequency of the fourth modulated signal−[1−p(t)] sin(ω_{LO}t) to generate a fourth frequency-multiplied signal (Y_{2B}) [1−p(t)]² sin²(ω_{LO}t) of the frequency-multiplied signals.

The first multi-combiner network 612a may be operable to receive the frequency-multiplied signals and combine the frequency-multiplied signals according to the equation Y=(Y_{1A}²−Y_{1B}²)−(Y_{2A}²−Y_{2B}²) to generate a combined signal (Y) 4p(t) cos(2ω_{LO}t) having a carrier frequency in a range from 200 GHz to 10 THz. However, in other embodiments, the carrier frequency may be in a different range, such as from 300 GHz to 3 THz, from 300 GHz to 10 THz, or from 500 GHz to 3 THz, for example.

In some embodiments, the combined signal (Y) 4p(t) cos(2ω_{LO}t) is the antenna feed signal. In some embodiments, the carrier frequency is an integer multiple of the LO frequency. In some such embodiments, a ratio of the carrier frequency to the LO frequency is a power of two.

The first multi-combiner network 612a may comprise a plurality of combination circuits 616a-n (hereinafter the “combiners 616” or individually each a “combiner 616”) (e.g., a first combiner 616a, a second combiner 616b, and a third combiner 616c shown in FIG. 6). The combiners 616 may be operable to generate a plurality of summed signals (hereinafter the “summed signals” or individually each a “summed signal”).

The first combiner 616a may be operable to receive the first frequency-multiplied signal (Y_{1A}) [1+p(t)]² cos²(ω_{LO}t) and the second frequency-multiplied signal (Y_{1B}) [1−p(t)]² cos²(ω_{LO}t) and combine the first frequency-multiplied signal (Y_{1A}) [1+p(t)]² cos²(ω_{LO}t) and the second frequency-multiplied signal (Y_{1B}) [1−p(t)]² cos²(ω_{LO}t) according to the equation Y₁=Y_{1A}²−Y_{1B}² to generate a first summed signal (Y₁) 2p(t)[1+cos(2ω_{LO}t)] of the summed signals.

The second combiner 616b may be operable to receive the third frequency-multiplied signal (Y_{2A}) [1+p(t)]² sin²(ω_{LO}t) and the fourth frequency-multiplied signal (Y_{2B}) [1−p(t)]² sin² (ω_{LO}t) and combine the third frequency-multiplied signal (Y_{2A}) [1+p(t)]² sin² (ω_{LO}t) and the fourth frequency-multiplied signal (Y_{2B}) [1−p(t)]² sin²(ω_{LO}t) according to the equation Y₂=Y_{2A}²−Y_{2B}² to generate a second summed signal (Y₂) 2p(t)[1−cos(2ω_{LO}t)] of the summed signals.

The third combiner 616c may be operable to receive the first summed signal (Y₁) 2p(t)[1+cos(2ω_{LO}t)] and the second summed signal (Y₂) 2p(t)[1−cos(2ω_{LO}t)] and combine the first summed signal (Y₁) 2p(t) [1+cos(2ω_{LO}t)] and the second summed signal (Y₂) 2p(t)[1−cos(2ω_{LO}t)] according to the equation Y=Y₁−Y₂ to generate the combined signal (Y) 4p(t) cos(2ω_{LO}t).

In some embodiments, one or more of the elements of the transmitter circuitry 516 (e.g., the first LO 602a, the modulators 604, the frequency multipliers 608, and the first multi-combiner network 612a) are active elements including one or more transistor, wherein the active elements may have a maximum power gain frequency. In such embodiments, the carrier frequency may be greater than the maximum power gain frequency of the active elements by a factor in a range from two to five.

Referring now to FIG. 7, shown therein is another exemplary embodiment of the transmitter circuitry 516 shown in FIG. 5. In the embodiment shown in FIG. 7, the transmitter circuitry 516 may be configured to implement SSB modulation. In the embodiment shown in FIG. 7, the transmitter circuitry 516 comprises a second frequency multiplier slice 600b (hereinafter the “I frequency multiplier slice 600b”), a third frequency multiplier slice 600c (hereinafter the “Q frequency multiplier slice 600c”), a second LO 602b, a second phase shifter 614b, a third phase shifter 614c, and a second multi-combiner network 612b. In the embodiment shown in FIG. 7, the baseband signal (BB) p(t) is a quadrature signal having an I baseband signal component p_{I}(t) and a Q baseband signal component p_{Q}(t).

Similar to the first LO 602a discussed above, the second LO 602b may be operable to generate the LO signal (LO) cos(ω_{LO}t) having the LO frequency ω_{LO} in the range from 100 GHz to 500 GHz, from 150 GHz to 400 GHz, from 200 GHz to 300 GHz, or from 100 GHz to 300 GHz, for example.

Unlike the first phase shifter 614a discussed above, the second phase shifter 614b may be operable to receive the LO signal cos(ω_{LO}t) and adjust the phase of the LO signal cos(ω_{LO}t) to generate a second phase-shifted LO signal sin(ω_{LO}t). In some embodiments, as shown in FIG. 7, the second phase shifter 614b may be operable to adjust the phase of the LO signal cos(ω_{LO}t) by +90 degrees to generate the second phase-shifted LO signal sin(ω_{LO}t).

The third phase shifter 614c may be operable to receive the LO signal cos(ω_{LO}t) and the second phase-shifted LO signal sin(ω_{LO}t) and adjust the phases of the LO signal cos(ω_{LO}t) and the second phase-shifted LO signal sin(ω_{LO}t) to generate a third phase-shifted LO signal 1/\sqrt{2}[(cos(ω_{LO}t)−sin(ω_{LO}t)] and a fourth phase-shifted LO signal 1/\sqrt{2}[(cos(ω_{LO}t)+sin(ω_{LO}t)], respectively. As shown in FIG. 7, the phase adjustment by the third phase shifter 614c may correspond to a 45° phase shift.

The I frequency multiplier slice 600b may be operable to receive the I baseband signal component p_{I}(t), the LO signal cos(ω_{LO}t), and the second phase-shifted LO signal sin(ω_{LO}t), and generate a first combined signal (Y_{I}) (hereinafter the “I combined signal”) 4p_{I}(t) cos(2ω_{LO}t) based on the I baseband signal component p_{I}(t), the LO signal cos(ω_{LO}t), and the second phase-shifted LO signal sin(ω_{LO}t).

The Q frequency multiplier slice 600c may be operable to receive the Q baseband signal component p_{Q}(t), the third phase-shifted LO signal 1/\sqrt{2}[(cos(ω_{LO}t)−sin(ω_{LO}t)], and the fourth phase-shifted LO signal 1/\sqrt{2}[(cos(ω_{LO}t)+sin(ω_{LO}t)] and generate a second combined signal (Y_{Q}) (hereinafter the “Q combined signal”) 4p_{Q}(t) sin(2ω_{LO}t) based on the Q baseband signal component p_{Q}(t), the third phase-shifted LO signal 1/\sqrt{2}[(cos(ω_{LO}t)−sin(ω_{LO}t)], and the fourth phase-shifted LO signal 1/\sqrt{2}[(cos(ω_{LO}t)+sin(ω_{LO}t)].

The second multi-combiner network 612b may be operable to receive the I combined signal (Y_{I}) 4p_{I}(t) cos(2ω_{LO}t) and the Q combined signal (Y_{Q}) 4p_{Q}(t) sin(2ω_{LO}t) and combine the I combined signal (Y_{I}) 4p_{I}(t) cos(2ω_{LO}t) and the Q combined signal (Y_{Q}) 4p_{Q}(t) sin(2ω_{LO}t) according to the equation Y=Y_{I}−Y_{Q} to generate the combined signal (Y) 4p_{I}(t) cos(2ω_{LO}t)−4p_{Q}(t) sin(2ω_{LO}t).

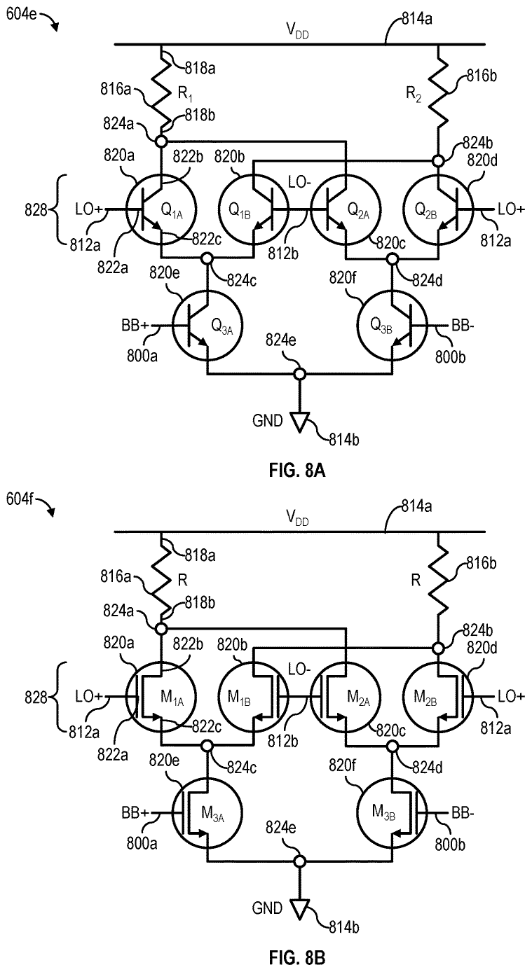

Referring now to FIG. 8A, shown therein is an exemplary embodiment of a fifth modulator 604e constructed in accordance with the present disclosure. However, it should be understood that any of the modulators 604 described herein may be constructed in a similar manner as the fifth modulator 604e.

In some embodiments, as shown in FIGS. 8A and 8B, the fifth modulator 604e may be a double-balanced linear modulator operable to perform real multiplication of a differential baseband signal received at a first baseband signal component input 800a (BB+) (hereinafter the “positive baseband signal component input 800a”) and a second baseband signal component input 800b (BB−) (hereinafter the “negative baseband signal component input 800b”) and a differential LO signal received at a first LO signal component input 812a (LO+) (hereinafter the “positive LO signal component input 812a”) and a second LO signal component input 812b (LO−) (hereinafter the “negative LO signal component input 812b”). In some embodiments, the positive baseband signal component input 800a (BB+) and the negative baseband signal component input 800b (BB−) may be operable to receive signals at low frequencies (e.g., in a range from 1 GHz to 200 GHz, from 10 GHz to 100 GHz, or from 50 GHz to 150 GHz).

The fifth modulator 604e may further comprise a first power supply connection 814a (V_{DD}) (hereinafter the “power supply voltage connection 814a”) and a second power supply connection 814b (GND) (hereinafter the “power supply ground connection 814b”).

The fifth modulator 604e may further comprise one or more resistors 816a-n (hereinafter the “resistors 816” or individually each a “resistor 816”) (e.g., a first resistor 816a (R1) and a second resistor 816b (R₂) shown in FIG. 8A). Each of the resistors 816 may have a first end 818a, a second end 818b opposite the first end 818a, and a resistance in a range from 50 ohms to 100 ohms. For purposes of clarity, only the first end 818a and the second end 818b of the first resistor 816a (R1) are labeled with a reference character.

The first resistor 816a (R₁) may be coupled to the power supply voltage connection 814a at the first end 818a and a first common node 824a at the second end 818b. The second resistor 816b may be coupled to the power supply voltage connection 814a at the first end 818a and a second common node 824b at the second end 818b. In some embodiments, one or more of the resistors 816 may be replaced with an inductor. In such embodiments, each of the inductors may have an inductance in a range from 50 ohms to 200 ohms.

The fifth modulator 604e may further comprise one or more transistors 820a-n (hereinafter the “transistors 820” or individually each a “transistor 820”) (e.g., a first transistor 820a (Q_{1A}), a second transistor 820b (Q_{1B}), a third transistor 820c (Q_{2A}), a fourth transistor 820d (Q_{2B}), a fifth transistor 820e (Q_{3A}), and a sixth transistor 820f (Q_{3B}) shown in FIG. 8A). Each of the transistors 820 may have a base terminal 822a, a collector terminal 822b, and an emitter terminal 822c. For purposes of clarity, only the base terminal 822a, the collector terminal 822b, and the emitter terminal 822c of the first transistor 820a (Q_{1A}) are labeled with a reference character. In the embodiment shown in FIG. 8A, the transistors 820 are bipolar transistors. However, it should be understood that other embodiments of the fifth modulator 604e may include different kinds of transistors, as is described in more detail below.

The first transistor 820a (Q_{1A}) may be coupled to the positive LO signal component input 812a at the base terminal 822a, the first common node 824a at the collector terminal 822b, and a third common node 824c at the emitter terminal 822c. The second transistor 820b (Q_{1B}) may be coupled to the negative LO signal component input 812b at the base terminal 822a, the second common node 824b at the collector terminal 822b, and the third common node 824c at the emitter terminal 822c.

The third transistor 820c (Q_{2A}) may be coupled to the negative LO signal component input 812b at the base terminal 822a, the first common node 824a at the collector terminal 822b, and a fourth common node 824d at the emitter terminal 822c. The fourth transistor 820d (Q_{2B}) may be coupled to the positive LO signal component input 812a at the base terminal 822a, the second common node 824b at the collector terminal 822b, and the fourth common node 824d at the emitter terminal 822c.

The fifth transistor 820e (Q_{3A}) may be coupled to the positive baseband signal component input 800a at the base terminal 822a, the third common node 824c at the collector terminal 822b, and a fifth common node 824e at the emitter terminal 822c. The sixth transistor 820f (Q_{3B}) may be coupled to the negative baseband signal component input 800b at the base terminal 822a, the fourth common node 824d at the collector terminal 822b, and the fifth common node 824e at the emitter terminal 822c. The fifth common node 824e may be coupled to the power supply ground connection 814b.

The fifth transistor 820e (Q_{3A}) and the sixth transistor 820f (Q_{3B}) may be operable to perform voltage-to-current conversion wherein the differential baseband signal received at the positive baseband signal component input 800a (BB+) and the negative baseband signal component input 800b (BB−) is converted from a voltage-domain representation to a current-domain representation and provided at the third common node 824c and the fourth common node 824d.

The current-domain representation may be related to the voltage-domain representation according to the equation Iₒᵤₜ=gₘ*Vᵢₙ, where Iₒᵤₜ is the differential output current (i.e., the current-domain representation provided at the third common node 824c and the fourth common node 824d) and Vᵢₙ is the input differential voltage (i.e., the voltage-domain representation received at the positive baseband signal component input 800a (BB+) and the negative baseband signal component input 800b (BB−)).

The differential output current lout is provided to a quad-transistor switching circuit 828 consisting of the first transistor 820a (Q_{1A}), the second transistor 820b (Q_{1B}), the third transistor 820c (Q_{2A}), and the fourth transistor 820d (Q_{2B}). The quad-transistor switching circuit 828 may be operable to mix the current-domain representation of the differential baseband signal with the differential LO signal received at the positive LO signal component input 812a (LO+) and the negative LO signal component input 812b (LO−) to generate an output current. In some embodiments, the transistors 820 that form the quad-transistor switching circuit 828 may be configured to operate at a frequency in a range from 0.5 THz to 1 THz. However, in other embodiments, the transistors 820 may be configured to operate at a frequency in a different range, such as from 300 GHz to 3 THz, or from 500 GHz to 2 THz, for example.

The output current generated by the quad-transistor switching circuit 828 may be provided to a load (i.e., the first resistor 816a (R₁) and the second resistor 816b (R₂)) to generate an output voltage provided to the first common node 824a and the second common node 824b.

Referring now to FIG. 8B, shown therein is an exemplary embodiment of a sixth modulator 604f constructed in accordance with the present disclosure. However, it should be understood that any of the modulators 604 described herein may be constructed in a similar manner as the sixth modulator 604f.

The sixth modulator 604f may be constructed in a similar manner as the fifth modulator 604e except that, in some embodiments, one or more of the transistors 820 of the sixth modulator 604f may be a metal-oxide-semiconductor field-effect transistor (MOSFET) (e.g., the first transistor 820a (M_{1A}), the second transistor 820b (M_{1B}), the third transistor 820c (M_{2A}), the fourth transistor 820d (M_{2B}), the fifth transistor 820e (M_{3A}), and the sixth transistor 820f (M_{3B}) shown in FIG. 8B). However, in other embodiments, one or more of the transistors 820 may be replaced with a current supply circuit (not shown).

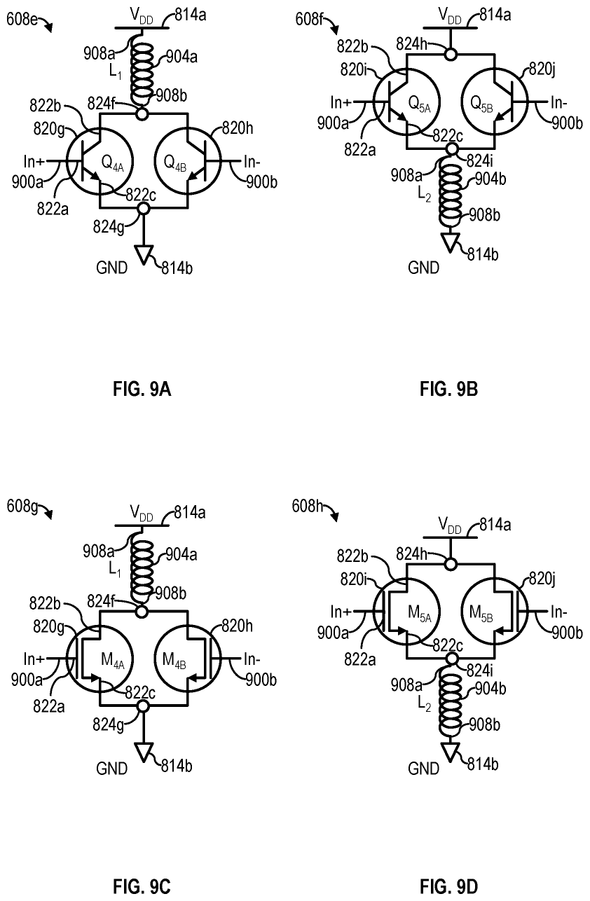

Referring now to FIG. 9A, shown therein is an exemplary embodiment of a fifth frequency multiplier 608e constructed in accordance with the present disclosure. However, it should be understood that any of the frequency multipliers 608 described herein may be constructed in a similar manner as the fifth frequency multiplier 608e.

The frequency multipliers 608 may be nonlinear frequency multipliers and may be operable to generate a higher-order output signal based on a differential input signal received at a first signal component input 900a (In+) (hereinafter the “positive signal component input 900a”) and a second signal component input 900b (In−) (hereinafter the “negative signal component input 900b”) and provide the output signal at a sixth common node 824f.

The fifth frequency multiplier 608e may further comprise the power supply voltage connection 814a (V_{DD}) and the power supply ground connection 814b (GND).

The fifth frequency multiplier 608e may further comprise one or more inductors 904a-n (hereinafter the “inductors 904” or individually each an “inductor 904”) (e.g., a first inductor 904a (L₁) shown in FIG. 9A). Each of the inductors 904 may have a first end 908a and a second end 908b opposite the first end 908a and may have an inductance in a range from 50 picohenries (pH) to 200 pH. The output signal may be extracted at the sixth common node 824f by a load (i.e., the first inductor 904a (L₁)). The fifth frequency multiplier 608e may further comprise one or more of the transistors 820 (e.g., a seventh transistor 820g (Q_{4A}) and an eighth transistor 820h (Q_{4B}) shown in FIG. 9A). Each of the transistors 820 may have the base terminal 822a, the collector terminal 822b, and the emitter terminal 822c. For purposes of clarity, only the base terminal 822a, the collector terminal 822b, and the emitter terminal 822c of the seventh transistor 820g (Q_{4A}) are labeled with a reference character.

The first inductor 904a (L₁) may be coupled to the power supply voltage connection 814a at the first end 908a and the sixth common node 824f at the second end 908b.

The seventh transistor 820g (Q_{4A}) may be coupled to the positive signal component input 900a at the base terminal 822a, the sixth common node 824f at the collector terminal 822b, and a seventh common node 824g at the emitter terminal 822c. The eighth transistor 820h (Q_{4B}) may be coupled to the negative signal component input 900b at the base terminal 822a, the sixth common node 824f at the collector terminal 822b, and the seventh common node 824g at the emitter terminal 822c.

In some embodiments, as shown in FIG. 9A, the seventh transistor 820g (Q_{4A}) and the eighth transistor 820h (Q_{4B}) may be nonlinear transistors and may be operable to generate an output signal characterized by a polynomial series representation. In some embodiments, the collector terminal 822b of the seventh transistor 820g (Q_{4A}) and the collector terminal 822b of the eighth transistor 820h (Q_{4B}) may be connected at the sixth common node 824f and the emitter terminal 822c of the seventh transistor 820g (Q_{4A}) and the emitter terminal 822c of the eighth transistor 820h (Q_{4B}) may be connected at the seventh common node 824g such that even harmonics (i.e., a second harmonic, a fourth harmonic, a sixth harmonic, etc.) of the input signal are provided at the sixth common node 824f.

In addition to the emitter terminal 822c of the seventh transistor 820g (Q_{4A}) and the emitter terminal 822c of the eighth transistor 820h (Q_{4B}), the seventh common node 824g may be further connected to the power supply ground connection 814b (GND).

Referring now to FIG. 9B, shown therein is an exemplary embodiment of a sixth frequency multiplier 608f constructed in accordance with the present disclosure. However, it should be understood that any of the frequency multipliers 608 described herein may be constructed in a similar manner as the sixth frequency multiplier 608f. In some embodiments, one or more of the frequency multipliers 608 described herein may comprise both of the fifth frequency multiplier 608e and the sixth frequency multiplier 608f.

The sixth frequency multiplier 608f may comprise one or more of the inductors 904 (e.g., a second inductor 904b (L₂) shown in FIG. 9B). Each of the inductors 904 may have the first end 908a and the second end 908b opposite the first end 908a.

The sixth frequency multiplier 608f may further comprise one or more of the transistors 820 (e.g., a ninth transistor 820i and a tenth transistor 820j shown in FIG. 9B). Each of the transistors 820 may have the base terminal 822a, the collector terminal 822b, and the emitter terminal 822c. For purposes of clarity, only the base terminal 822a, the collector terminal 822b, and the emitter terminal 822c of the ninth transistor 820i (Q_{5A}) are labeled with a reference character.

The ninth transistor 820i (Q_{5A}) may be coupled to the positive signal component input 900a at the base terminal 822a, an eighth common node 824h at the collector terminal 822b, and a ninth common node 824i at the emitter terminal 822c. The tenth transistor 820j (Q_{5B}) may be coupled to the negative signal component input 900b at the base terminal 822a, the eighth common node 824h at the collector terminal 822b, and the ninth common node 824i at the emitter terminal 822c. The output signal may be extracted at the ninth common node 824i by a load (the second inductor 904b (L₂)).

The second inductor 904b (L₂) may be coupled to the ninth common node 824i at the first end 908a and the power supply ground connection 814b at the second end 908b.

In some embodiments, as shown in FIG. 9B, the ninth transistor 820i (Q_{5A}) and the tenth transistor 820j (Q_{5B}) may be nonlinear transistors and may be operable to generate an output signal characterized by a polynomial series representation. In some embodiments, the collector terminal 822b of the ninth transistor 820i (Q_{5A}) and the collector terminal 822b of the tenth transistor 820j (Q_{5B}) may be connected at the eighth common node 824h and the emitter terminal 822c of the ninth transistor 820i (Q_{5A}) and the emitter terminal 822c of the tenth transistor 820j (Q_{5B}) may be connected at the ninth common node 824i such that even harmonics (i.e., a second harmonic, a fourth harmonic, a sixth harmonic, etc.) of the input signal are provided at the ninth common node 824i.

In addition to the collector terminal 822b of the ninth transistor 820i (Q_{5A}) and the collector terminal 822b of the tenth transistor 820j (Q_{5B}), the eighth common node 824h may be further connected to the power supply voltage connection 814a (V_{DD}).

Referring now to FIG. 9C, shown therein is an exemplary embodiment of a seventh frequency multiplier 608g constructed in accordance with the present disclosure. However, it should be understood that any of the frequency multipliers 608 described herein may be constructed in a similar manner as the seventh frequency multiplier 608g.

The seventh frequency multiplier 608g may be constructed in a similar manner as the fifth frequency multiplier 608e except that, in some embodiments, one or more of the transistors 820 of the seventh frequency multiplier 608g may be a MOSFET (e.g., the seventh transistor 820g (M_{4A}) and the eighth transistor 820h (M_{4B}) shown in FIG. 9C). However, in other embodiments, one or more of the transistors 820 may be replaced with a current supply circuit (not shown).

Referring now to FIG. 9D, shown therein is an exemplary embodiment of an eighth frequency multiplier 608h constructed in accordance with the present disclosure. However, it should be understood that any of the modulators 604 described herein may be constructed in a similar manner as the eighth frequency multiplier 608h. In some embodiments, one or more of the frequency multipliers 608 described herein may comprise both of the seventh frequency multiplier 608g and the eighth frequency multiplier 608h.

The eighth frequency multiplier 608h may be constructed in a similar manner as the sixth frequency multiplier 608f except that, in some embodiments, one or more of the transistors 820 of the eighth frequency multiplier 608h may be a MOSFET (e.g., the ninth transistor 820i (M_{5A}) and the tenth transistor 820j (M_{5B}) shown in FIG. 9D). However, in other embodiments, one or more of the transistors 820 may be replaced with a current supply circuit (not shown).

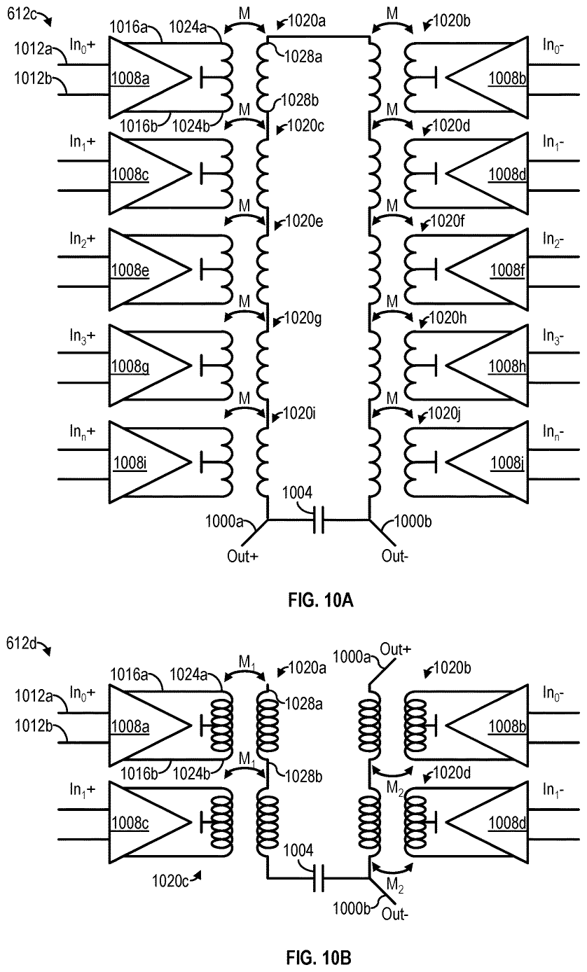

Referring now to FIG. 10A, shown therein is an exemplary embodiment of a third multi-combiner network 612c constructed in accordance with the present disclosure. However, it should be understood that any of the multi-combiner networks 612 described herein may be constructed in a similar manner as the third multi-combiner network 612c.

The third multi-combiner network 612c may comprise a first output terminal 1000a (Out+) (hereinafter the “positive output terminal 1000a”), a second output terminal 1000b (Out−) (hereinafter the “negative output terminal 1000b”), a capacitor 1004, a plurality of output driver circuits 1008a-n (hereinafter the “output drivers 1008” or individually each an “output driver 1008”) (e.g., a first output driver 1008a, a second output driver 1008b, a third output driver 1008c, a fourth output driver 1008d, a fifth output driver 1008e, a sixth output driver 1008f, a seventh output driver 1008g, an eighth output driver 1008h, a ninth output driver 1008i, and a tenth output driver 1008j shown in FIG. 10A), and a plurality of transformer circuits 1020a-n (hereinafter the “transformers 1020” or individually each a “transformer 1020”) (e.g., a first transformer 1020a, a second transformer 1020b, a third transformer 1020c, a fourth transformer 1020d, a fifth transformer 1020e, a sixth transformer 1020f, a seventh transformer 1020g, an eighth transformer 1020h, a ninth transformer 1020i, and a tenth transformer 1020j shown in FIG. 10A).

The capacitor 1004 may be coupled between the positive output terminal 1000a and the negative output terminal 1000b and may have a capacitance in a range from 5 femtofarads (fF) to 20 fF.

Each of the output drivers 1008 may have one or more input terminals 1012a-n (In₀₋ₙ+/−) (hereinafter the “input terminals 1012” or individually each an “input terminal 1012”) (e.g., a first input terminal 1012a (In₀+) and a second input terminal 1012b (In₀−) shown in FIG. 10A) and one or more output terminals 1016a-n (hereinafter the “output terminals 1016” or individually each an “output terminal 1016”) (e.g., a first output terminal 1016a and a second output terminal 1016b shown in FIG. 10A). For purposes of clarity, only the first input terminal 1012a (In₀+), the second input terminal 1012b (In₀−), the first output terminal 1016a, and the second output terminal 1016b of the first output driver 1008a are labeled with a reference character.

Each particular one of the output drivers 1008 may have a corresponding one of the transformers 1020 coupled to the output terminals 1016 of the particular output driver 1008. In some embodiments, one or more of the transformers 1020 is a Balun. Each of the transformers 1020 may have one or more primary terminals 1024a-n (hereinafter the “primary terminals 1024” or individually each a “primary terminal 1024”) (e.g., a first primary terminal 1024a and a second primary terminal 1024b shown in FIG. 10A) and one or more secondary terminals 1028a-n (hereinafter the “secondary terminals 1028” or individually each a “secondary terminal 1028”) (e.g., a first secondary terminal 1028a and a second secondary terminal 1028b shown in FIG. 10A). For purposes of clarity, only the first primary terminal 1024a, the second primary terminal 1024b, the first secondary terminal 1028a, and the second secondary terminal 1028b of the first transformer 1020a are labeled with a reference character.

As shown in FIGS. 10A and 10B, the transformers 1020 may be further characterized by a mutual inductance, denoted by labels M, M₁, and M₂, which may represent magnetic coupling between the primary terminals 1024 and the corresponding secondary terminals 1028 of each of the transformers 1020.

In the embodiment shown in FIG. 10A, the third multi-combiner network 612c is in a series configuration (i.e., the secondary terminals 1028 of each of the transformers 1020 are connected in series) in which the third multi-combiner network 612c is operable to receive a plurality of input signals (hereinafter the “input signals” or individually each an “input signal”) at the first input terminal 1012a and the second input terminal 1012b of each of the output drivers 1008 and combine the input signals such that an output signal provided at the positive output terminal 1000a and the negative output terminal 1000b represents a linear sum of the voltage of each of the input signals.

Referring now to FIG. 10B, shown therein is an exemplary embodiment of a fourth multi-combiner network 612d constructed in accordance with the present disclosure. However, it should be understood that any of the multi-combiner networks 612 described herein may be constructed in a similar manner as the fourth multi-combiner network 612d.

The fourth multi-combiner network 612d may be constructed in a similar manner as the third multi-combiner network 612c except that, in the embodiment shown in FIG. 10B, the fourth multi-combiner network 612d is in a parallel configuration (i.e., the secondary terminals 1028 of each of the transformers 1020 are connected in parallel) in which the fourth multi-combiner network 612d is operable to receive the input signals at the first input terminal 1012a and the second input terminal 1012b of each of the output drivers 1008 and combine the input signals such that the output signal provided at the positive output terminal 1000a and the negative output terminal 1000b represents a linear sum of the current of each of the input signals.

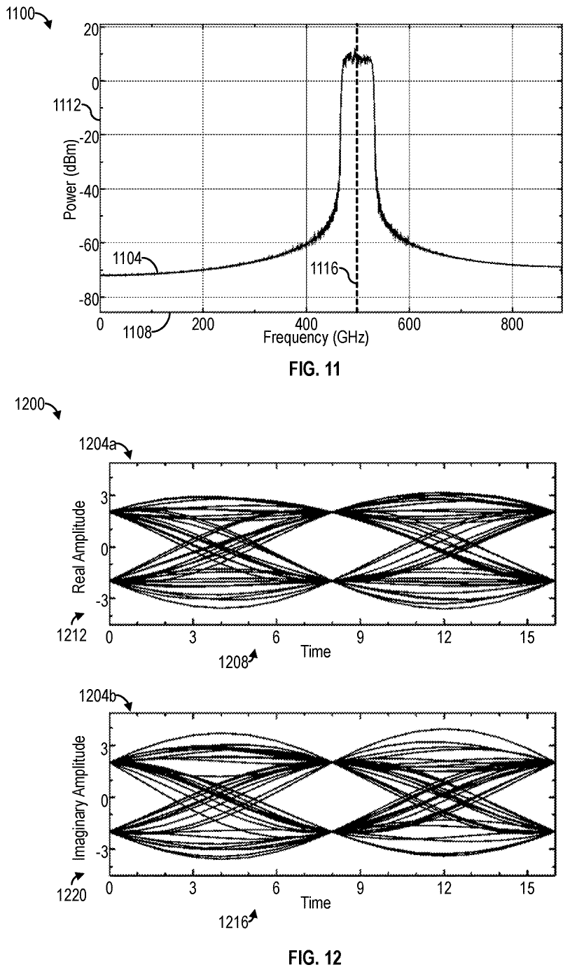

Referring now to FIG. 11, shown therein is a spectral graph 1100 of exemplary embodiment of the combined signal 1104 (Y) generated by the transmitter circuitry 516 shown in FIGS. 6 and 7. A spectral graph x-axis 1108 shows a frequency of the combined signal 1104 (Y) measured in GHz and a spectral graph y-axis 1112 shows a power of the combined signal 1104 (Y) measured in decibel-milliwatts (dBm).

As shown in FIG. 11, in some embodiments, the combined signal 1104 (Y) may have a center frequency 1116 of 500 GHz. However, it should be understood that in other embodiments, the center frequency of the combined signal 1104 (Y) may be in a range from 200 GHz to 10 THz, from 500 GHz to 10 THz, from 300 GHz to 3 THz, from 300 GHz to 10 THz, or from 500 GHz to 3 THz, for example.

Referring now to FIG. 12, shown therein is a complex eye diagram 1200 of another exemplary embodiment of the combined signal 1104 (Y) generated by the transmitter circuitry 516 shown in FIGS. 6 and 7. The complex eye diagram 1200 includes a real (i.e., I) eye diagram 1204a of the I signal component of the combined signal 1104 (Y) and an imaginary (i.e., Q) eye diagram 1204b of the Q signal component of the combined signal 1104 (Y). In the real eye diagram 1204a, a real x-axis 1208 shows time, and a real y-axis 1212 shows a real amplitude of the I signal component of the combined signal 1104 (Y). In the imaginary eye diagram 1204b, an imaginary x-axis 1216 shows a time, and an imaginary y-axis 1220 shows an imaginary amplitude of the Q signal component of the combined signal 1104 (Y).

As shown in FIG. 12, in some embodiments, the transmitter circuitry 516 described herein may generate the combined signal 1104 (Y) as a quadrature signal in which linearity is preserved for both the I signal component (as shown in the real eye diagram 1204a) and the Q signal component (as shown in the imaginary eye diagram 1204b). That is, the combined signal 1104 (Y) maintains consistent and evenly spaced amplitude levels in both the I signal component and the Q signal component.

### ILLUSTRATIVE CLAUSES

Exemplary, non-limiting illustrative clauses are provided in the clauses below. However, the scope of the present inventive concept(s) is to be understood to not be limited in any manner by the clauses presented below.
Illustrative clause 1. A network element, comprising: a client-side input operable to receive a differential baseband signal comprising a pair of complementary baseband signal components; an oscillation circuit operable to generate a differential local oscillator (LO) signal having an LO frequency in a range from 100 Gigahertz (GHz) to 500 GHz and comprising a pair of complementary LO signal components; a plurality of modulation circuits operable to generate a plurality of modulated signals, each of the plurality of modulation circuits being operable to receive a particular complementary baseband signal component of the pair of complementary baseband signal components and a particular complementary LO signal component of the pair of complementary LO signal components and modulate the particular complementary baseband signal component onto the particular complementary LO signal component to generate a particular one of the plurality of modulated signals; a plurality of frequency multiplication circuits operable to generate a plurality of frequency-multiplied signals, each of the plurality of frequency multiplication circuits being operable to receive a particular one of the plurality of modulated signals and multiply a frequency of the particular one of the plurality of modulated signals to generate a particular one of the plurality of frequency-multiplied signals; a combination circuit operable to receive the plurality of frequency-multiplied signals and combine each of the plurality of frequency-multiplied signals to generate a combined signal having a carrier frequency in a range from 200 GHz to 10 Terahertz (THz); and an antenna operable to receive the combined signal, generate a transmission signal as a radiated electromagnetic wave based on the combined signal, and couple the transmission signal into a THz waveguide.
Illustrative clause 2. The network element of illustrative clause 1, wherein data is encoded in the pair of complementary baseband signal components using a pulse amplitude modulation-n (PAM-n) format, wherein n is an integer.
Illustrative clause 3. The network element of illustrative clause 1, wherein at least one of the plurality of modulation circuits is a real modulation circuit.
Illustrative clause 4. The network element of illustrative clause 1, wherein at least one of the plurality of modulation circuits is a complex modulation circuit.
Illustrative clause 5. The network element of illustrative clause 1, wherein at least one of the plurality of modulation circuits is a double sideband (DSB) mixing circuit.
Illustrative clause 6. The network element of illustrative clause 1, wherein at least one of the plurality of modulation circuits is a single sideband (SSB) mixing circuit.
Illustrative clause 7. The network element of illustrative clause 1, wherein at least one of the plurality of frequency multiplication circuits is a frequency-doubling circuit.
Illustrative clause 8. The network element of illustrative clause 1, further comprising a pulse-shaping circuit operable to receive the pair of complementary baseband signal components and shape a pulse of each of the pair of complementary baseband signal components to apply a predetermined pulse shape to the pulse of each of the pair of complementary baseband signal components.
Illustrative clause 9. The network element of illustrative clause 8, wherein the pulse-shaping circuit is further operable to apply pre-emphasis to each of the pair of complementary baseband signal components such that a bandwidth of each of the pair of complementary baseband signal components is reduced.
Illustrative clause 10. The network element of illustrative clause 1, wherein the oscillation circuit is operable to generate a single-ended reference LO signal, and wherein the oscillation circuit further comprises a phase-shifting circuit operable to receive the single-ended reference LO signal and shift a phase of the single-ended reference LO signal to generate a particular complementary LO signal component of the pair of complementary LO signal components of the differential LO signal, the other particular complementary LO signal component of the pair of complementary LO signal components being the single-ended reference LO signal.
Illustrative clause 11. The network element of illustrative clause 10, further comprising a phase calibration circuit operable to receive the pair of complementary LO signal components and modify a phase of one or more of the pair of complementary LO signal components such that each of the pair of complementary LO signal components are orthogonal to each other.
Illustrative clause 12. The network element of illustrative clause 11, wherein the phase calibration circuit is a phase and amplitude calibration circuit and is operable to modify an amplitude of one or more of the pair of complementary LO signal components to equalize the amplitude of each of the pair of complementary LO signal components.
Illustrative clause 13. The network element of illustrative clause 1, wherein the carrier frequency is an integer multiple of the LO frequency.
Illustrative clause 14. The network element of illustrative clause 13, wherein a ratio of the carrier frequency to the LO frequency is a power of two.
Illustrative clause 15. The network element of illustrative clause 1, wherein the network element comprises one or more active elements including at least one of the oscillation circuit, the plurality of modulation circuits, the plurality of frequency multiplication circuits, and the combination circuit, each of the one or more active elements including a transistor, the carrier frequency being greater than a maximum power gain frequency of each of the one or more active elements by a factor in a range from two to five.
Illustrative clause 16. A network element, comprising: a client-side input operable to receive a differential baseband signal comprising a pair of complementary baseband signal components including a first complementary baseband signal component and a second complementary baseband signal component, the first complementary baseband signal component including a first in-phase (I) baseband signal component and a first quadrature (Q) baseband signal component, the second complementary baseband signal component including a second I baseband signal component and a second Q baseband signal component; an oscillation circuit operable to generate a differential local oscillator (LO) signal having an LO frequency in a range from 100 Gigahertz (GHz) to 500 GHz and comprising a pair of complementary LO signal components including a first complementary LO signal component and a second complementary LO signal component, the first complementary LO signal component including a first I LO signal component and a first Q LO signal component, the second complementary LO signal component including a second I LO signal component and a second Q LO signal component; a first frequency multiplication circuit operable to receive the first I baseband signal component, the second I baseband signal component, the first I LO signal component, and the second I LO signal component and generate a first frequency-multiplied signal based on the first I baseband signal component, the second I baseband signal component, the first I LO signal component, and the second I LO signal component, the first frequency-multiplied signal having a first intermediate frequency greater than the LO frequency; a second frequency multiplication circuit operable to receive the first Q baseband signal component, the second Q baseband signal component, the first Q LO signal component, and the second Q LO signal component and generate a second frequency-multiplied signal based on the first Q baseband signal component, the second Q baseband signal component, the first Q LO signal component, and the second Q LO signal component, the second frequency-multiplied signal having a second intermediate frequency greater than the LO frequency; a combination circuit operable to receive the first frequency-multiplied signal and the second frequency-multiplied signal and combine the first frequency-multiplied signal and the second frequency-multiplied signal to generate a combined signal having a carrier frequency in a range from 200 GHz to 10 THz; and an antenna operable to receive the combined signal, generate a transmission signal as a radiated electromagnetic wave based on the combined signal, and couple the transmission signal into a THz waveguide.
Illustrative clause 17. The network element of illustrative clause 16, wherein data is encoded in the differential baseband signal using a modulation format, wherein the modulation format is one of an m-quadrature amplitude modulation (m-QAM) format, a quadrature phase-shift keying (QPSK) modulation format, and a pulse amplitude modulation-n (PAM-n) format, wherein m and n are integers.
Illustrative clause 18. The network element of illustrative clause 16, wherein at least one of the first frequency multiplication circuit and the second frequency multiplication circuit includes a complex modulation circuit.
Illustrative clause 19. The network element of illustrative clause 16, wherein at least one of the first frequency multiplication circuit and the second frequency multiplication circuit includes a double sideband (DSB) mixing circuit.
Illustrative clause 20. The network element of illustrative clause 16, wherein at least one of the first frequency multiplication circuit and the second frequency multiplication circuit includes a single sideband (SSB) mixing circuit.
Illustrative clause 21. The network element of illustrative clause 16, wherein at least one of the first frequency multiplication circuit and the second frequency multiplication circuit includes a frequency-doubling circuit.
Illustrative clause 22. The network element of illustrative clause 16, further comprising a pulse-shaping circuit operable to receive the pair of complementary baseband signal components and shape a pulse of each of the pair of complementary baseband signal components to apply a predetermined pulse shape to the pulse of each of the pair of complementary baseband signal components.
Illustrative clause 23. The network element of illustrative clause 22, wherein the pulse-shaping circuit is further operable to apply pre-emphasis to each of the pair of complementary baseband signal components to reduce a bandwidth of each of the pair of complementary baseband signal components.
Illustrative clause 24. The network element of illustrative clause 16, wherein the oscillation circuit is operable to generate a single-ended reference LO signal, and wherein the oscillation circuit further comprises a phase-shifting circuit operable to receive the single-ended reference LO signal and shift a phase of the single-ended reference LO signal to generate a particular complementary LO signal component of the pair of complementary LO signal components of the differential LO signal, the other particular complementary LO signal component of the pair of complementary LO signal components being the single-ended reference LO signal.
Illustrative clause 25. The network element of illustrative clause 24, further comprising a phase calibration circuit operable to receive the pair of complementary LO signal components and modify a phase of one or more of the pair of complementary LO signal components such that each of the pair of complementary LO signal components are orthogonal to each other.
Illustrative clause 26. The network element of illustrative clause 25, wherein the phase calibration circuit is a phase and amplitude calibration circuit and is further operable to modify an amplitude of one or more of the pair of complementary LO signal components to equalize the amplitude of each of the pair of complementary LO signal components.
Illustrative clause 27. The network element of illustrative clause 16, wherein the carrier frequency is an integer multiple of the LO frequency.
Illustrative clause 28. The network element of illustrative clause 16, wherein a ratio of the carrier frequency to the LO frequency is a power of two.
Illustrative clause 29. The network element of illustrative clause 16, wherein the network element comprises one or more active elements including at least one of the oscillation circuit, the first frequency multiplication circuit, the second frequency multiplication circuit, and the combination circuit, each of the one or more active elements including a transistor, the carrier frequency being greater than a maximum power gain frequency of each of the one or more active elements by a factor in a range from two to five.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

1. A network element, comprising:
a client-side input operable to receive a differential baseband signal comprising a pair of complementary baseband signal components;
an oscillation circuit operable to generate a differential local oscillator (LO) signal having an LO frequency in a range from 100 Gigahertz (GHz) to 500 GHz and comprising a pair of complementary LO signal components;
a plurality of modulation circuits operable to generate a plurality of modulated signals, each of the plurality of modulation circuits being operable to receive a particular complementary baseband signal component of the pair of complementary baseband signal components and a particular complementary LO signal component of the pair of complementary LO signal components and modulate the particular complementary baseband signal component onto the particular complementary LO signal component to generate a particular one of the plurality of modulated signals;
a plurality of frequency multiplication circuits operable to generate a plurality of frequency-multiplied signals, each of the plurality of frequency multiplication circuits being operable to receive a particular one of the plurality of modulated signals and multiply a frequency of the particular one of the plurality of modulated signals to generate a particular one of the plurality of frequency-multiplied signals;
a combination circuit operable to receive the plurality of frequency-multiplied signals and combine each of the plurality of frequency-multiplied signals to generate a combined signal having a carrier frequency in a range from 100 GHz to 10 Terahertz (THz); and
an antenna operable to receive the combined signal, generate a transmission signal as a radiated electromagnetic wave based on the combined signal, and couple the transmission signal into a THz waveguide.

2. The network element of claim 1, wherein data is encoded in the pair of complementary baseband signal components using a pulse amplitude modulation-n (PAM-n) format, wherein n is an integer.

3. The network element of claim 1, wherein at least one of the plurality of modulation circuits is a real modulation circuit.

4. The network element of claim 1, wherein at least one of the plurality of modulation circuits is a complex modulation circuit.

5. The network element of claim 1, wherein at least one of the plurality of modulation circuits is a double sideband (DSB) mixing circuit.

6. The network element of claim 1, wherein at least one of the plurality of modulation circuits is a single sideband (SSB) mixing circuit.

7. The network element of claim 1, wherein at least one of the plurality of frequency multiplication circuits is a frequency-doubling circuit.

8. The network element of claim 1, further comprising a pulse-shaping circuit operable to receive the pair of complementary baseband signal components and shape a pulse of each of the pair of complementary baseband signal components to apply a predetermined pulse shape to the pulse of each of the pair of complementary baseband signal components.

9. The network element of claim 8, wherein the pulse-shaping circuit is further operable to apply pre-emphasis to each of the pair of complementary baseband signal components such that a bandwidth of each of the pair of complementary baseband signal components is reduced.

10. The network element of claim 1, wherein the oscillation circuit is operable to generate a single-ended reference LO signal, and wherein the oscillation circuit further comprises a phase-shifting circuit operable to receive the single-ended reference LO signal and shift a phase of the single-ended reference LO signal to generate a particular complementary LO signal component of the pair of complementary LO signal components of the differential LO signal, the other particular complementary LO signal component of the pair of complementary LO signal components being the single-ended reference LO signal.

11. The network element of claim 10, further comprising a phase calibration circuit operable to receive the pair of complementary LO signal components and modify a phase of one or more of the pair of complementary LO signal components such that each of the pair of complementary LO signal components are orthogonal to each other.

12. The network element of claim 11, wherein the phase calibration circuit is a phase and amplitude calibration circuit and is operable to modify an amplitude of one or more of the pair of complementary LO signal components to equalize the amplitude of each of the pair of complementary LO signal components.

13. The network element of claim 1, wherein the carrier frequency is an integer multiple of the LO frequency.

14. The network element of claim 13, wherein a ratio of the carrier frequency to the LO frequency is a power of two.

15. The network element of claim 1, wherein the network element comprises one or more active elements including at least one of the oscillation circuit, the plurality of modulation circuits, the plurality of frequency multiplication circuits, and the combination circuit, each of the one or more active elements including a transistor, the carrier frequency being greater than a maximum power gain frequency of each of the one or more active elements by a factor in a range from two to five.

16. A network element, comprising:
a client-side input operable to receive a differential baseband signal comprising a pair of complementary baseband signal components including a first complementary baseband signal component and a second complementary baseband signal component, the first complementary baseband signal component including a first in-phase (I) baseband signal component and a first quadrature (Q) baseband signal component, the second complementary baseband signal component including a second I baseband signal component and a second Q baseband signal component;
an oscillation circuit operable to generate a differential local oscillator (LO) signal having an LO frequency in a range from 100 Gigahertz (GHz) to 500 GHz and comprising a pair of complementary LO signal components including a first complementary LO signal component and a second complementary LO signal component, the first complementary LO signal component including a first I LO signal component and a first Q LO signal component, the second complementary LO signal component including a second I LO signal component and a second Q LO signal component;
a first frequency multiplication circuit operable to receive the first I baseband signal component, the second I baseband signal component, the first I LO signal component, and the second I LO signal component and generate a first frequency-multiplied signal based on the first I baseband signal component, the second I baseband signal component, the first I LO signal component, and the second I LO signal component, the first frequency-multiplied signal having a first intermediate frequency greater than the LO frequency;
a second frequency multiplication circuit operable to receive the first Q baseband signal component, the second Q baseband signal component, the first Q LO signal component, and the second Q LO signal component and generate a second frequency-multiplied signal based on the first Q baseband signal component, the second Q baseband signal component, the first Q LO signal component, and the second Q LO signal component, the second frequency-multiplied signal having a second intermediate frequency greater than the LO frequency;
a combination circuit operable to receive the first frequency-multiplied signal and the second frequency-multiplied signal and combine the first frequency-multiplied signal and the second frequency-multiplied signal to generate a combined signal having a carrier frequency in a range from 100 GHz to 10 THz; and
an antenna operable to receive the combined signal, generate a transmission signal as a radiated electromagnetic wave based on the combined signal, and couple the transmission signal into a THz waveguide.

17. The network element of claim 16, wherein data is encoded in the differential baseband signal using a modulation format, wherein the modulation format is one of an m-quadrature amplitude modulation (m-QAM) format, a quadrature phase-shift keying (QPSK) modulation format, and a pulse amplitude modulation-n (PAM-n) format, wherein m and n are integers.

18. The network element of claim 16, wherein at least one of the first frequency multiplication circuit and the second frequency multiplication circuit includes a complex modulation circuit.

19. The network element of claim 16, wherein at least one of the first frequency multiplication circuit and the second frequency multiplication circuit includes a double sideband (DSB) mixing circuit.

20. The network element of claim 16, wherein at least one of the first frequency multiplication circuit and the second frequency multiplication circuit includes a single sideband (SSB) mixing circuit.

21. The network element of claim 16, wherein at least one of the first frequency multiplication circuit and the second frequency multiplication circuit includes a frequency-doubling circuit.

22. The network element of claim 16, further comprising a pulse-shaping circuit operable to receive the pair of complementary baseband signal components and shape a pulse of each of the pair of complementary baseband signal components to apply a predetermined pulse shape to the pulse of each of the pair of complementary baseband signal components.

23. The network element of claim 22, wherein the pulse-shaping circuit is further operable to apply pre-emphasis to each of the pair of complementary baseband signal components to reduce a bandwidth of each of the pair of complementary baseband signal components.

24. The network element of claim 16, wherein the oscillation circuit is operable to generate a single-ended reference LO signal, and wherein the oscillation circuit further comprises a phase-shifting circuit operable to receive the single-ended reference LO signal and shift a phase of the single-ended reference LO signal to generate a particular complementary LO signal component of the pair of complementary LO signal components of the differential LO signal, the other particular complementary LO signal component of the pair of complementary LO signal components being the single-ended reference LO signal.

25. The network element of claim 24, further comprising a phase calibration circuit operable to receive the pair of complementary LO signal components and modify a phase of one or more of the pair of complementary LO signal components such that each of the pair of complementary LO signal components are orthogonal to each other.

26. The network element of claim 25, wherein the phase calibration circuit is a phase and amplitude calibration circuit and is further operable to modify an amplitude of one or more of the pair of complementary LO signal components to equalize the amplitude of each of the pair of complementary LO signal components.

27. The network element of claim 16, wherein the carrier frequency is an integer multiple of the LO frequency.

28. The network element of claim 16, wherein a ratio of the carrier frequency to the LO frequency is a power of two.

29. The network element of claim 16, wherein the network element comprises one or more active elements including at least one of the oscillation circuit, the first frequency multiplication circuit, the second frequency multiplication circuit, and the combination circuit, each of the one or more active elements including a transistor, the carrier frequency being greater than a maximum power gain frequency of each of the one or more active elements by a factor in a range from two to five.
